(19) United States
(12) Patent Application Publication
(10) Pub. No.: US 2025/0177792 A1
(43) Pub. Date: Jun. 5, 2025

(54) SPRINKLER ASSEMBLY

(71) Applicant: Tyco Fire Products LP, Cranston, RI (US)

(72) Inventor: Sean E. Cutting, Wood River Junction, RI (US)

(73) Assignee: Tyco Fire Products LP, Cranston, RI (US)

(21) Appl. No.: 18/961,021

(22) Filed: Nov. 26, 2024

Related U.S. Application Data
(60) Provisional application No. 63/605,268, filed on Dec. 1, 2023.

(51) Int. Cl. A62C 35/68

(52) U.S. Cl. CPC A62C 35/68

(57) ABSTRACT

A sprinkler assembly can include a sprinkler. The sprinkler can include a base including a body and an engagement tab extending from the body. The sprinkler can include a frame extending from the base. The sprinkler assembly can include a fitting coupled with the sprinkler. The fitting can include an engagement slot to receive the engagement tab of the sprinkler. The sprinkler assembly can include a seal slot defined by at least one of the base of the sprinkler and the fitting. The seal slot can receive a seal element to form a seal between the fitting and the sprinkler.

### CROSS-REFERENCE TO RELATED APPLICATIONS

The present application claims the benefit of and priority to U.S. Provisional Application No. 63/605,268, filed Dec. 1, 2023, the disclosure of which is incorporated herein by reference in its entirety.

### BACKGROUND

Sprinkler systems are used to deliver fluid to a location at which a fire may be taking place. Sprinkler systems can be actuated in response to trigger conditions, such as smoke or heat.

### SUMMARY

At least one aspect is directed to a sprinkler assembly. The sprinkler assembly can include a sprinkler. The sprinkler can include a base that can include a body and an engagement tab extending from the body. The sprinkler can include a frame extending from the base. The sprinkler assembly can include a fitting coupled with the sprinkler. The fitting can include an engagement slot to receive the engagement tab of the sprinkler. The sprinkler assembly can include a seal slot defined by at least one of the base of the sprinkler and the fitting. The seal slot can receive a seal element to form a seal between the fitting and the sprinkler.

At least one aspect is directed to a sprinkler assembly. The sprinkler assembly can include a sprinkler. The sprinkler can include a base. The sprinkler can include a frame extending from the base. The sprinkler assembly can include an adapter coupled with the sprinkler. A portion of the base can be disposed in the adapter. The adapter can include an engagement tab. The sprinkler assembly can include a fitting coupled with the adapter. The fitting can include an engagement slot to receive the engagement tab. The sprinkler assembly can include a seal slot defined by at least one of the adapter or the fitting. The seal slot can receive a seal element to form a seal between the fitting and the adapter.

At least one aspect is directed to a sprinkler assembly. The sprinkler assembly can include a sprinkler. The sprinkler can include a base. The sprinkler can include a frame extending from an end of the base. The sprinkler can include a flange extending radially from a side of the base. The sprinkler assembly can include a fitting coupled with the sprinkler. The fitting can include a fitting surface facing the flange. The fitting can include an engagement feature to interface with the base to couple the sprinkler with the fitting. The sprinkler assembly can include a seal element disposed between the flange and the fitting surface to form a seal between the sprinkler and the fitting.

At least one aspect is directed to a fitting of a sprinkler assembly. The fitting can include an inner wall and an outer wall, the inner wall defines a cavity. The fitting can include an engagement slot extending into the inner wall. The engagement slot can include an inlet to receive an engagement tab of the sprinkler assembly. The engagement slot can include a rotational portion to facilitate rotation of a sprinkler of the sprinkler assembly relative to the fitting with the engagement tab in the rotational portion.

At least one aspect is directed to an adapter of a sprinkler assembly. The adapter can include an inner wall and an outer wall, the inner wall defines a cavity to receive a portion of a sprinkler of the sprinkler assembly. The adapter can include an engagement feature to engage the sprinkler, the engagement feature at least partially disposed in the cavity. The adapter can include an engagement tab to engage a fitting of the sprinkler assembly, the engagement tab extending from the outer wall.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example sprinkler system.

FIG. 2 depicts an example sprinkler assembly.

FIG. 3 depicts an example sprinkler.

FIG. 4 depicts an example fitting.

FIG. 5 depicts a cross-sectional view of an example sprinkler assembly.

FIG. 6 depicts an example sprinkler assembly.

FIG. 7 depicts an example sprinkler.

FIG. 8 depicts an example adapter.

FIG. 9 depicts an example fitting.

FIG. 10 depicts a cross-sectional view of an example sprinkler assembly.

FIG. 11 depicts a cross-sectional view of an example sprinkler assembly.

### DETAILED DESCRIPTION

Following below are more detailed descriptions of various concepts related to, and implementations of, methods, apparatuses, and systems of fire protection sprinklers. The various concepts introduced above and discussed in greater detail below may be implemented in any of numerous ways.

The present disclosure generally relates to a sprinkler system. More particularly, the present disclosure relates to sprinkler assemblies that can be a part of a sprinkler system. Sprinklers can have various shapes and sizes which can make it difficult to find an appropriate fitting to couple a sprinkler with a pipe of a sprinkler system that is the correct size and forms a seal that is tight enough to prevent fire suppressant fluid from leaking from the system. Further, sprinklers can require additional materials or components (e.g., tape) and numerous actions (e.g., several threaded turns) to create a seal that prevents leaks. The present disclosure provides sprinkler assemblies that are easy to couple with a pipe of a sprinkler system (e.g., without additional materials or repetitive actions) and that seal the sprinkler assemblies to prevent fluid leakage. The components of the sprinkler assemblies can include seal elements to form seals to reduce leakage of fire suppressant fluid that flows through the sprinkler assembly. An adapter can be provided that can facilitate use of the same or similar fittings for standard sprinklers or sprinklers of different sizes (e.g., residential sprinklers, storage sprinklers).

The sprinkler assemblies disclosed herein can include various configurations. For example, a sprinkler assembly can include a sprinkler coupled with a fitting. The sprinkler can include an engagement tab to engage a slot of the fitting to couple the sprinkler with the fitting. At least one of the sprinkler or the fitting can define a sealing feature (e.g., a groove) to receive a seal element (e.g., a gasket) to form a seal between the sprinkler and the fitting.

A sprinkler assembly can include a sprinkler coupled with an adapter and the adapter coupled with a fitting. The sprinkler can be threadably coupled with the adapter. The adapter can include an engagement tab to engage a slot of the fitting to couple the adapter with the fitting. The sprinkler can be coupled with the fitting via the adapter. At least one of the adapter or the fitting can define a sealing feature (e.g., a groove) to receive a seal element (e.g., a gasket) for form a seal between the adapter and the fitting.

A sprinkler assembly can include a sprinkler coupled with a fitting. The sprinkler can be threadably coupled with the fitting. The sprinkler can have a flange. The fitting can have a surface that faces the flange. A seal element (e.g., a gasket) can be disposed between the flange and the surface of the fitting to form a seal between the sprinkler and the fitting. The sprinkler can define a pocket to receive the seal element.

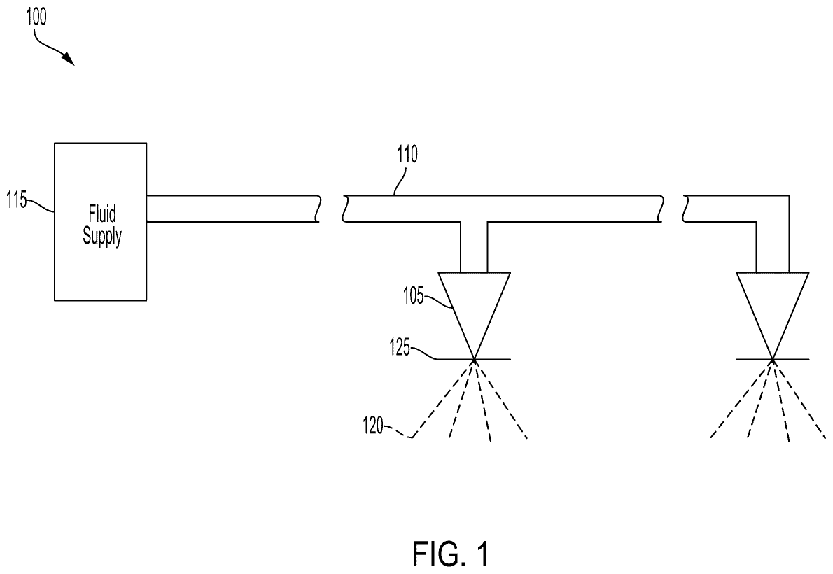

FIG. 1 depicts at least one example sprinkler system 100. The sprinkler system 100 can include at least one sprinkler or sprinkler assembly 105, piping 110 (e.g., one or more pipes, tubes, conduits), and at least one fluid supply 115. The sprinkler 105 can be coupled with (e.g., mounted on or connected with) piping 110 and can be or include any kind of sprinkler (e.g., electronically activated sprinkler (EAS), early suppression fast response (ESFR) sprinkler, extended coverage (EC) sprinkler, rapid install sprinkler (RIS)). The sprinkler 105 can have any orientation. For example, the sprinkler 105 can be a pendent sprinkler (e.g., extend below the piping 110), an upright sprinkler 105 (e.g., extend upward from the piping 110), or a sidewall sprinkler 105 (e.g., extend sideways from the piping 110), among others.

The piping 110 can be any material. For example, the piping 110 can be black steel, stainless steel, CPVC, or copper, among others. The piping 110 can include one or more main pipes, connected with the fluid supply 115, from which one or more branch lines can extend. The piping 110 can be fluidly coupled with one or more sprinklers 105. The sprinkler assemblies 105 can receive water or other fire suppressant fluids 120 from the fluid supply 115 via the piping 110. The sprinkler assemblies 105 each define one or more outlets, through which the fire suppressant fluid 120 can exit and contact at least one deflector 125 to form a spray of water or other fire suppressant fluid 120 that covers a desired area. The fire suppressant fluid 120 from the sprinkler assemblies 105 then suppress or extinguish fire within that area.

The sprinkler system 100 can distribute at least one fire suppressant fluid 120 onto or nearby a fire, extinguishing the fire and preventing the fire from spreading. The sprinkler system 100 can be used to protect various spaces or buildings or to actuate a valve (e.g., for dry pilot activation). The sprinkler system 100 can be used alone or in conjunction with other types of fire suppression systems (e.g., other building sprinkler systems, a handheld fire extinguisher). The sprinkler system 100 can be used with a variety of fire suppressant fluids 120, including but not limited to water (e.g., powders, liquids, foams, or other fluid or flowable materials).

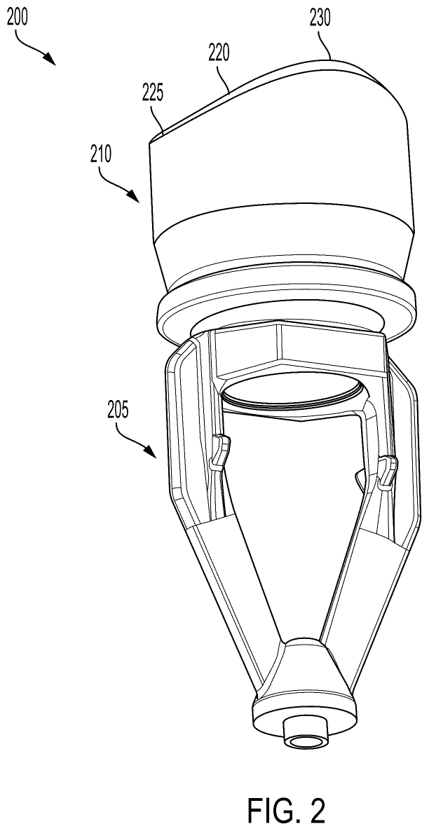

FIG. 2 depicts an example sprinkler assembly 200. The sprinkler assembly 200 can be a part of a sprinkler system 100. For example, the sprinkler assembly 105 can be or include sprinkler assembly 200. The sprinkler assembly 200 can couple with a piping 110 of a sprinkler system 100. The sprinkler system 100 can include a plurality of sprinkler assemblies 200.

The sprinkler assembly 200 can include at least one sprinkler 205. The sprinkler 205 can be any sprinkler 205 that can receive a fire suppressant fluid 120 and dispense the fire suppressant fluid 120. For example, the sprinkler 205 can be a rapid install sprinkler (RIS) 205. The sprinkler assembly 200 can include at least one fitting 210. The fitting 210 can couple the sprinkler assembly 200 with the piping 110. For example, the fitting 210 can be a welded outlet to couple with the piping 110. The fitting 210 can couple with the sprinkler 205. The fitting 210 can couple the sprinkler 205 with the piping 110.

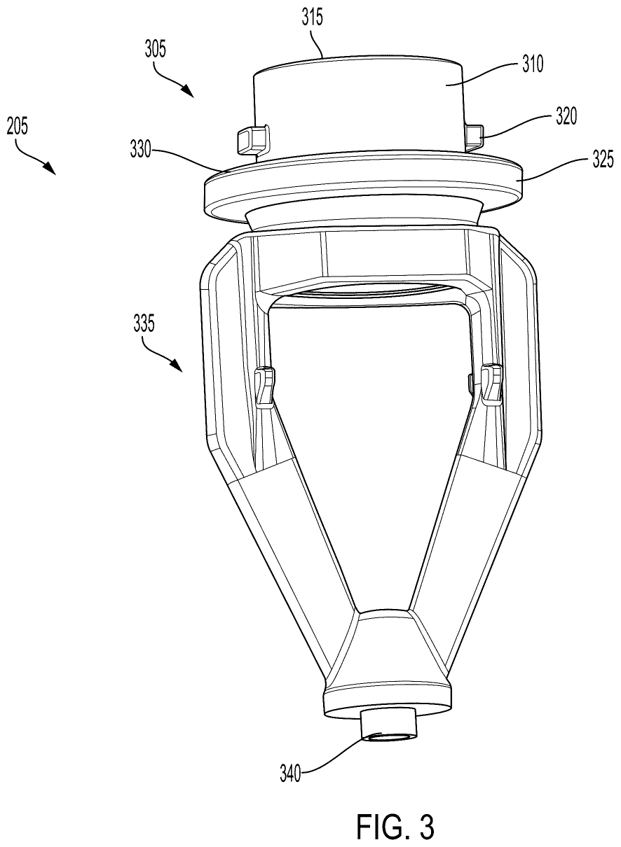

FIG. 3 depicts an example sprinkler 205. The sprinkler 205 can include at least one base 305. The base 305 can include at least one body 310. The body 310 can define a first sprinkler end 315 of the sprinkler 205. The base 305 can include at least one engagement tab 320. The engagement tab 320 can couple the sprinkler 205 with another component or device. For example, the engagement tab 320 can engage a corresponding engagement feature of another component. The engagement tab 320 can extend from the body 310. For example, the engagement tab 320 can extend radially outward from the body 310. The base 305 can include a plurality of engagement tabs 320. The engagement tabs 320 can be circumferentially spaced around the base 305. The engagement tabs 320 can be spaced apart based on a target degree of rotation of the sprinkler 205 to couple the sprinkler 205 with the other component. The engagement tab 320 can include, for example, a straight or curved tab, hook, protrusion, or latch.

The base 305 can include at least one flange 325. The flange 325 can extend radially outward from the base 305. The flange 325 can extend around a perimeter of the base 305. The engagement tab 320 can be disposed between the first sprinkler end 315 and the flange 325. The flange 325 can have at least one flange surface 330. The flange surface 330 can face the first sprinkler end 315. The flange surface 330 can interface with or be spaced away from an object coupled with the sprinkler 205.

The sprinkler 205 can include at least one head portion, shown as frame 335. The frame 335 can have any style, shape, size, or geometry. The frame 335 can extend from the base 305. The frame 335 can define a second sprinkler end 340 of the sprinkler 205. The engagement tab 320 can be disposed between the frame 335 and the first sprinkler end 315. The flange 325 can be disposed between the frame 335 and the first sprinkler end 315. The frame 335 can extend in an axial direction opposite the body 310.

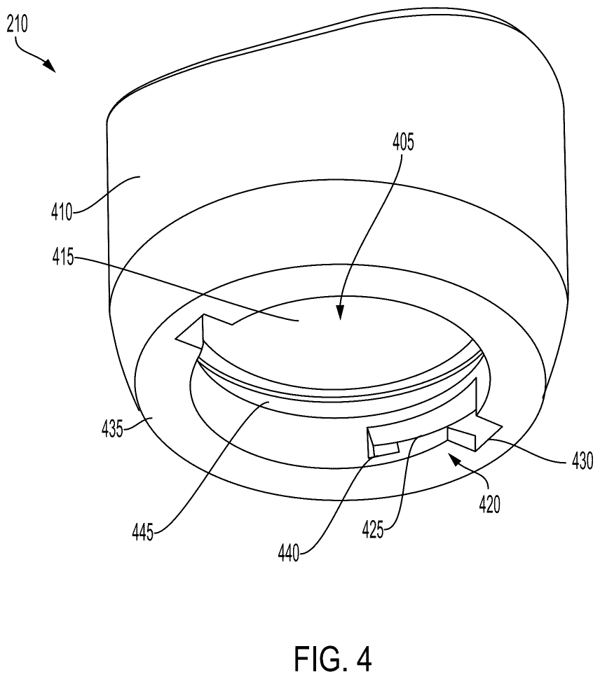

FIG. 4 depicts an example fitting 210. The fitting 210 can couple with a sprinkler 105. For example, an engagement tab 320 of the sprinkler 205 and at least a portion of the body 310 can be disposed in the fitting 210. The fitting 210 can couple a sprinkler 205 with piping 110. The fitting 210 can define at least one cavity 405. For example, the fitting 210 can have at least one outer wall 410 and at least one inner wall 415. The inner wall 415 can define the cavity 405. At least a portion of the sprinkler 205 can be disposed in the cavity 405. For example, at least a portion of the body 310 can be disposed in the cavity 405 with the sprinkler 205 coupled with the fitting 210.

The fitting 210 can include at least one engagement slot 420. The engagement slot 420 can couple the fitting 210 with the sprinkler 205. For example, the engagement slot 420 can receive an engagement tab 320 of the sprinkler 205. The sprinkler 205 can couple with the fitting 210 with the engagement tab 320 disposed in the engagement slot 420. The engagement slot 420 can extend into the inner wall 415 of the fitting 210. For example, the engagement slot 420 can extend radially outward from the cavity 405 and into the inner wall 415. The engagement slot 420 can extend partially through the inner wall 415 such that the engagement slot 420 does not extend completely through the outer wall 410 of the fitting 210. For example, the engagement slot 420 can not connect the cavity 405 with an environment external to the fitting 210.

The engagement slot 420 can include at least one rotational portion 425. The rotational portion can facilitate rotation of the sprinkler 205 relative to the fitting 210 with an engagement tab 320 in the rotational portion 425. For example, the engagement tab 320 can slide along the rotational portion 425 to facilitate rotation of the sprinkler 205. The rotational portion 425 can extend circumferentially along the inner wall 415 of the fitting 210.

The engagement slots 420 and/or rotational portions 425 can be positioned relative to each other and/or sized (e.g., in circumferential length of the rotational portions 425) to allow for a targeted amount of turning of the sprinkler 205 to achieve a sealed fitting, and to cause the sprinkler 205 to be aligned with the piping 110 and/or fitting 210. For example, as depicted in FIG. 2, the fitting 210 can have an end surface 220 to contact the piping 110 (e.g., that is in contact with the piping 110 responsive to coupling of the piping 110 with the fitting 210, such as upon welding of the fitting 210 with the piping 110). The end surface 220 can vary shape, e.g., in curvature, between a first point 225 closest in distance (e.g., among points along the end surface 220) from fitting surface 435 to a second point 230 furthest from the fitting surface 435. This can allow the fitting 210 to be positioned in a particular orientation relative to the longitudinal axis, e.g., in-line with the run of the piping 110, responsive to being coupled with the piping 110. The engagement slots 420 and/or rotational portions 425 can be positioned relative to the end surface 220 (e.g., relative to at least one of the first point 225 and the second point 230) such that responsive to the sprinkler 205 being received at an end of the rotational portion 425, frame arms 350 of the sprinkler 205 are aligned with the piping 110, e.g., such that an axis through the frame arms 350 (and/or a plane in which the frame arms 350 lies) is parallel with the longitudinal axis of the piping 110.

The engagement slot 420 can include at least one inlet 430. The inlet 430 can receive an engagement tab 320. For example, the engagement tab 320 can enter the engagement slot 420 via the inlet 430. The inlet 430 can extend from the rotational portion 425 in a first direction and through an end of the fitting 210. For example, the fitting 210 can include at least one surface, shown as fitting surface 435. The fitting surface 435 can face the flange 325 with the sprinkler 205 coupled with the fitting 210. The flange surface 330 can be spaced away from or can contact the fitting surface 435. The fitting surface 435 can define at least a portion of the inlet 430. For example, the inlet 430 can extend from the fitting surface 435 to the rotational portion 425.

The engagement slot 420 can include at least one retention pocket 440. The retention pocket 440 can retain the engagement tab 320 to couple the sprinkler 205 with the fitting 210. The retention pocket 440 can extend from the rotational portion 425 in the same direction as the inlet 430. The retention pocket 440 can extend a second distance. For example, the inlet 430 can extend a first distance from the rotational portion 425 through the fitting surface 435. The retention pocket 440 can extend a second distance from the rotational portion 425 that is shorter than the first distance such that the retention pocket 440 can not extend through the fitting surface 435. A thickness of the fitting 210 from the retention pocket 440 to the fitting surface 435 can be sufficient to hold the sprinkler 205 against pressure of water from the piping 110 applied to the sprinkler 205 (e.g., to a seal in an outlet of the sprinkler 205 and/or against the deflector of the sprinkler 205).

The engagement slot 420 can have any size. For example, the engagement slot 420 can extend partially around the cavity 405. A size (e.g., a length) of the engagement slot 420 can be based on a desired turn angle to couple the sprinkler 205 with the fitting 210. For example, the sprinkler 205 can rotate relative to the fitting 210 a predetermined angle with the engagement tab 320 disposed in the engagement slot 420. For example, the engagement slot 420 can facilitate a quarter turn of the sprinkler 205 relative to the fitting 210 to couple the sprinkler 205 with the fitting 210. As noted above, the structure, size, and/or shape of the engagement slots 420 can allow for alignment of the sprinkler 205 (and thus the spray pattern of fluid output of the sprinkler 205) with the piping 110.

The fitting 210 can have a plurality of engagement slots 420. The plurality of engagement slots 420 can receive a plurality of engagement tabs 320. The engagement slots 420 can be positioned to facilitate proper orientation of the sprinkler 205 relative to the fitting 210. For example, the engagement slots 420 can be positioned to align with corresponding engagement tabs 320. The engagement slots 420 can be based on the predetermined turn angle of the sprinkler 205 such that the sprinkler 205 is oriented properly relative to the fitting 210 with the engagement tab 320 disposed in the retention pocket 440 of the engagement slot 420. As noted above, this can allow for achieving a target orientation of the sprinkler 205 relative to the piping 110 (e.g., responsive to engagement of the engagement tab 320 with the retention pocket 440).

The sprinkler assembly 200 can include at least one seal slot 445. The seal slot 445 can form and/or be used to form a seal between the fitting 210 and the sprinkler 205. The seal slot 445 can be defined by at least one of the base 305 (e.g., the body 310) of the sprinkler 205 or the fitting 210. For example, the seal slot 445 can extend into the inner wall 415 of the fitting 210. The seal slot 445 can extend circumferentially around the cavity 405 of the fitting 210. The seal slot 445 can extend into the body 310 of the base 305 of the sprinkler 205. The seal slot 445 can extend circumferentially around the base 305.

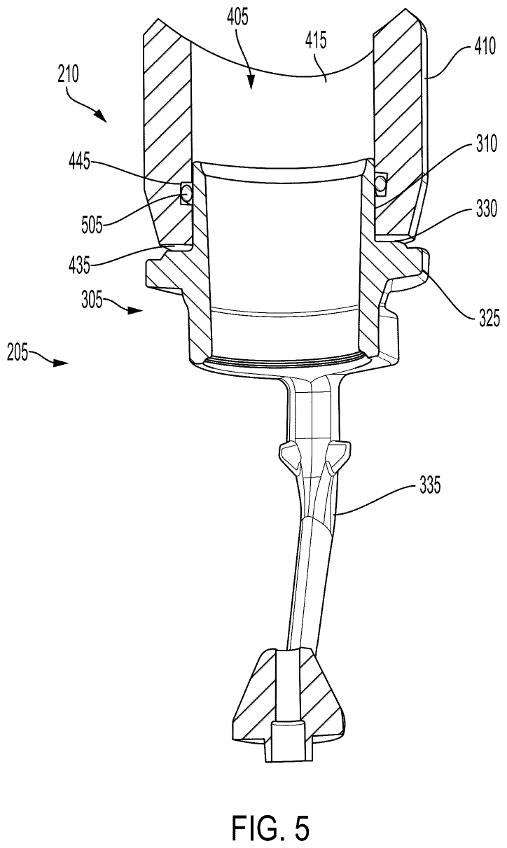

FIG. 5 depicts an example cross-sectional view of the sprinkler assembly 200. A portion of the sprinkler 205 can be disposed in the fitting 210. For example, at least a portion of the body 310 can be disposed in the cavity 405. The body 310 can interface with the inner wall 415 of the fitting 210. The flange surface 330 can face the fitting surface 435. The flange surface 330 can interface with the fitting surface 435 with the sprinkler 205 coupled with the fitting 210.

The sprinkler assembly 200 can include at least one seal element 505. The seal element 505 can be at least partially disposed in the seal slot 445. The seal element 505 can form a seal between the fitting 210 and the sprinkler 205, for example, in the seal slot 445. The seal element 505 can be, for example, a gasket or other compliant member that can form a seal. The seal element 505 can be pre-swelled and/or lubricated to facilitate more effective sealing under fire sprinkler pressure conditions.

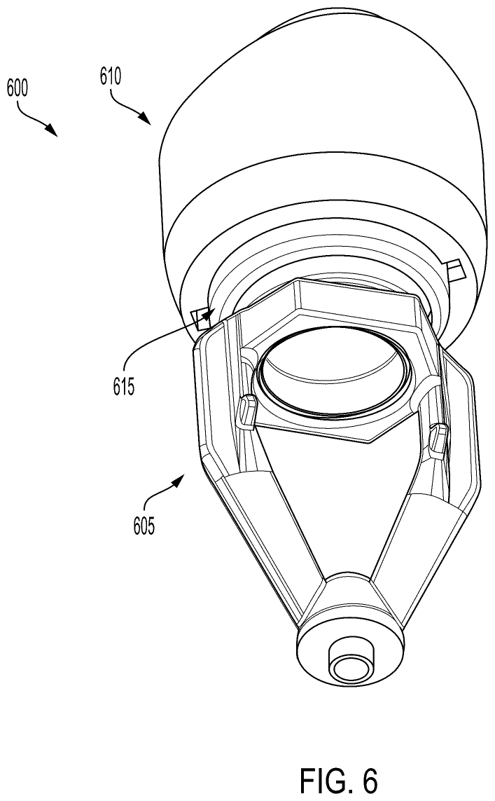

FIG. 6 depicts an example sprinkler assembly 600. The sprinkler assembly 600 can be a part of a sprinkler system 100. For example, the sprinkler assembly 105 can be or include sprinkler assembly 600. The sprinkler assembly 600 can couple with a piping 110 of a sprinkler system 100. The sprinkler system 100 can include a plurality of sprinkler assemblies 600.

The sprinkler assembly 600 can include at least one sprinkler 605. The sprinkler 605 can be any sprinkler 605 that can receive a fire suppressant fluid 120 and dispense the first suppressant fluid 120. For example, the sprinkler 605 can be an ESFR sprinkler 605. The sprinkler assembly 600 can include at least one fitting 610. The fitting 610 can be the same as or similar to fitting 210. The fitting 610 can couple the sprinkler assembly 600 with the piping 110. For example, the fitting 610 can be a welded outlet to couple with the piping 110. The fitting 610 can couple with the sprinkler 605. The fitting 210 can couple the sprinkler 605 with the piping 110.

The sprinkler assembly 600 can include at least one adapter 615. The adapter 615 can couple with the sprinkler 605. The fitting 610 can couple with the adapter 615. The fitting 610 can couple with the sprinkler 605 via the adapter 615. The adapter 615 can facilitate the coupling of a sprinkler 605 with the fitting 610 that cannot directly couple with the fitting 610. For example, the sprinkler 605 can have a shape or size that does not correspond with the fitting 610 (e.g., an outer diameter of the base 705 is too small to engage with the fitting 610). The shape and size of the adapter 615 can correspond with a shape and size of the sprinkler 605 and the fitting 610.

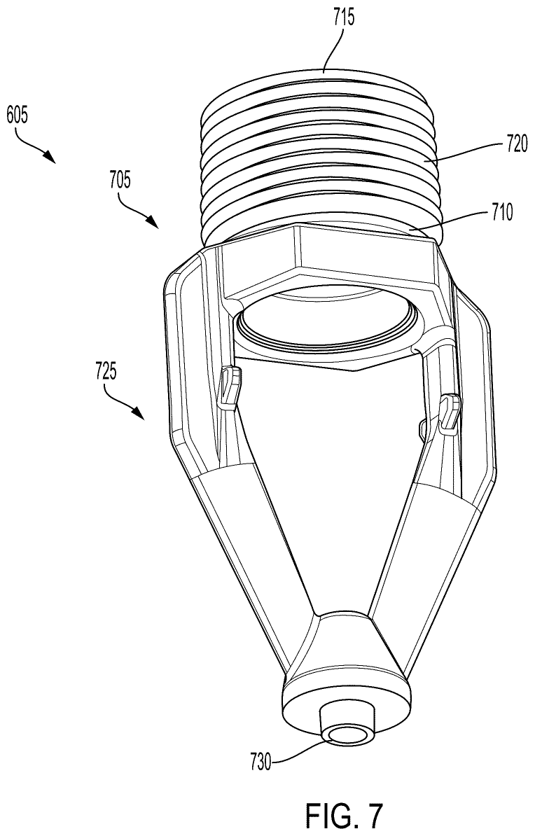

FIG. 7 depicts an example sprinkler 605. The sprinkler 605 can include at least one base 705. The base 705 can include at least one body 710. The body 710 can define a first sprinkler end 715 of the sprinkler 605. The base 705 can include at least one engagement feature 720. The engagement feature 720 can be, for example, a threaded portion. The engagement feature 720 can couple the sprinkler 605 with another component or device. For example, the engagement feature 720 can couple the sprinkler 605 with the adapter 615. The engagement feature 720 can extend along at least part of the body 710.

The sprinkler 605 can include at least one frame 725. The frame 725 can extend from the base 705. The frame 725 can define a second sprinkler end 730 of the sprinkler 605. The engagement feature 720 can be disposed between the frame 725 and the first sprinkler end 715. The frame 725 can extend in an axial direction opposite the body 710.

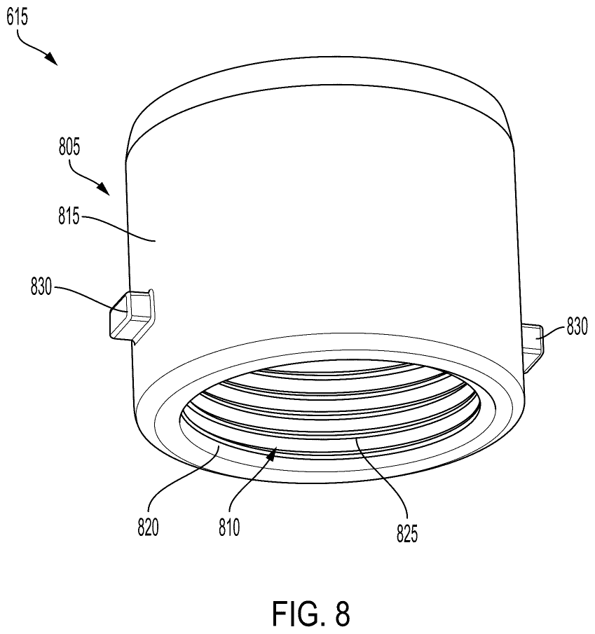

FIG. 8 depicts an example adapter 615. The adapter 615 can have an adapter body 805. The adapter 615 can define a cavity 810. For example, the adapter body 805 can have an outer wall 815 and an inner wall 820. The inner wall 820 can define the cavity 810. The cavity 810 can extend through the adapter 615.

The adapter 615 can couple with a sprinkler 605. For example, the cavity 810 can receive at least a portion of the sprinkler 605. For example, at least a portion of the base 705 (e.g., a portion of the body 710) can be disposed in the cavity 810 to couple the sprinkler 605 with the adapter 615. The adapter 615 can include at least one engagement feature 825. The engagement feature 825 can be disposed, at least partially, in the cavity 810. The engagement feature 825 can be, for example, a threaded portion. The engagement feature 825 of the adapter 615 can engage the engagement feature 720 of the sprinkler 605 to couple the sprinkler 605 with the adapter 615.

The adapter 615 can couple with a fitting 610. For example, the adapter 615 can include at least one engagement tab 830. The engagement tab 830 can engage a corresponding engagement feature of the fitting 610 to couple the adapter 615 with the fitting 610. The engagement tab 830 can extend from the adapter body 805. For example, the engagement tab 830 can extend radially outward from the outer wall 815 of the adapter body 805. The adapter 615 can include a plurality of engagement tabs 830. The engagement tabs 830 can be circumferentially spaced around the adapter 615. The engagement tabs 830 can be spaced apart based on a target degree of rotation of the adapter 615 to couple the adapter 615 with the fitting 610.

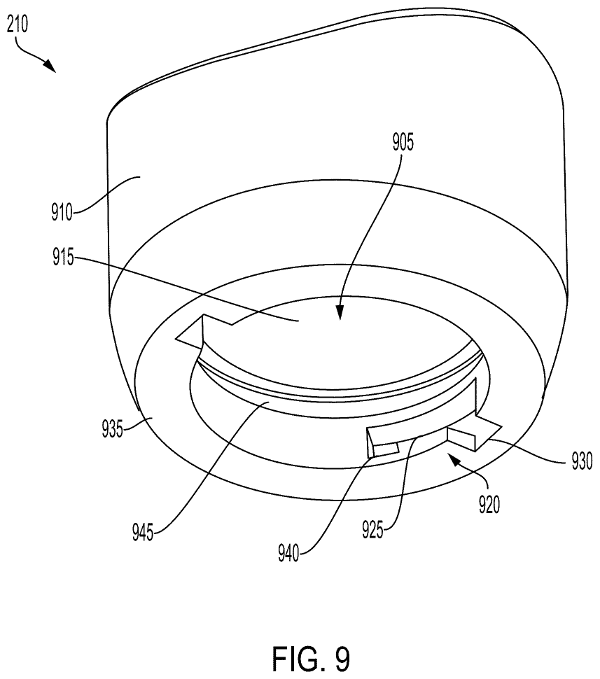

FIG. 9 depicts an example fitting 610. The fitting 610 can couple with a sprinkler 605. For example, the fitting 610 can couple with an adapter 615. The fitting 610 can couple with the sprinkler 605 via the adapter 615. The adapter 615 facilitates coupling a sprinkler 605 with the fitting 610 that alone can not couple with the fitting 610. For example, the body 710 of the sprinkler 605 can be too narrow such that the engagement feature 720 of the sprinkler 605 cannot engage an engagement feature of the fitting 610.

The fitting 610 can be the same as or similar to fitting 210. For example, an engagement tab 830 of the adapter 615 and at least a portion of the adapter body 805 can be disposed in the fitting 610. The fitting 610 can couple a sprinkler 605 with piping 110. The fitting 610 can define at least one fitting cavity 905. For example, the fitting 610 can have at least one outer wall 910 and at least one inner wall 915. The inner wall 915 can define the fitting cavity 905. At least a portion of the adapter 615 can be disposed in the fitting cavity 905. For example, at least a portion of the adapter body 805 can be disposed in the fitting cavity 905 with the adapter 615 coupled with the fitting 610.

The fitting 610 can include at least one engagement slot 920. The engagement slot 920 can couple the fitting 610 with the adapter 615. For example, the engagement slot 920 can receive an engagement tab 830 of the adapter 615. The adapter 615 can couple with the fitting 610 with the engagement tab adapter 615 disposed in the engagement slot 920. The engagement slot 920 can extend into the inner wall 915 of the fitting 610. For example, the engagement slot 920 can extend radially outward from the fitting cavity 905 and into the inner wall 915. The engagement slot 920 can extend partially through the inner wall 915 such that the engagement slot 920 does not extend completely through the outer wall 910 of the fitting 610. For example, the engagement slot 920 can not connect the fitting cavity 905 with an environment external to the fitting 610.

The engagement slot 920 can include at least one rotational portion 925. The rotational portion can facilitate rotation of the adapter 615 relative to the fitting 610 with an engagement tab 830 in the rotational portion 925. For example, the engagement tab 830 can slide along the rotational portion 925 to facilitate rotation of the adapter 615. The rotational portion 925 can extend circumferentially along the inner wall 915 of the fitting 610.

The engagement slot 920 can include at least one inlet 930. The inlet 930 can receive an engagement tab 830. For example, the engagement tab 830 can enter the engagement slot 920 via the inlet 930. The inlet 930 can extend from the rotational portion 925 in a first direction and through an end of the fitting 610. For example, the fitting 610 can include at least one surface, shown as fitting surface 935. The fitting surface 935 can face the frame 725 of the sprinkler 605 coupled with the adapter 615. The fitting surface 935 can define at least a portion of the inlet 930. For example, the inlet 930 can extend from the fitting surface 935 to the rotational portion 925.

The engagement slot 920 can include at least one retention pocket 940. The retention pocket 940 can retain the engagement tab 830 to couple the adapter 615 with the fitting 610. The retention pocket 940 can extend from the rotational portion 925 in the same direction as the inlet 930. The retention pocket 940 can extend a second distance. For example, the inlet 930 can extend a first distance from the rotational portion 925 through the fitting surface 935. The retention pocket 940 can extend a second distance from the rotational portion 925 that is shorter than the first distance such that the retention pocket 940 can not extend through the fitting surface 935.

The engagement slot 920 can have any size. For example, the engagement slot 920 can extend partially around the fitting cavity 905. A size (e.g., a length) of the engagement slot 920 can be based on a desired turn angle to couple the adapter 615 with the fitting 610. For example, the adapter 615 can rotate relative to the fitting 610 a predetermined angle with the engagement tab 830 disposed in the engagement slot 920. For example, the engagement slot 920 can facilitate a quarter turn of the adapter 615 relative to the fitting 610 to couple the adapter 615 with the fitting 210.

The fitting 610 can have a plurality of engagement slots 920. The engagement slots 920 can receive a plurality of engagement tabs 830. The engagement slots 920 can be positioned to facilitate proper orientation of the sprinkler 605 relative to the fitting 610. For example, the engagement slots 920 can be positioned to align with corresponding engagement tabs 830. The engagement slots 920 can be based on the predetermined turn angle of the adapter 615 and the sprinkler 605 such that the sprinkler 605 is oriented properly relative to the fitting 610 with the engagement tab 830 disposed in the retention pocket 940 of the engagement slot 920.

The sprinkler assembly 600 can include at least one seal slot 945. The seal slot 945 can form a seal between the fitting 610 and the adapter 615. The seal slot 945 can be defined by at least one of the adapter body 805 or the fitting 610. For example, the seal slot 945 can extend into the inner wall 915 of the fitting 610. The seal slot 945 can extend circumferentially around the fitting cavity 905. The seal slot 945 can extend into the outer wall 815 of the adapter body 805. The seal slot 945 can extend circumferentially around the body 805.

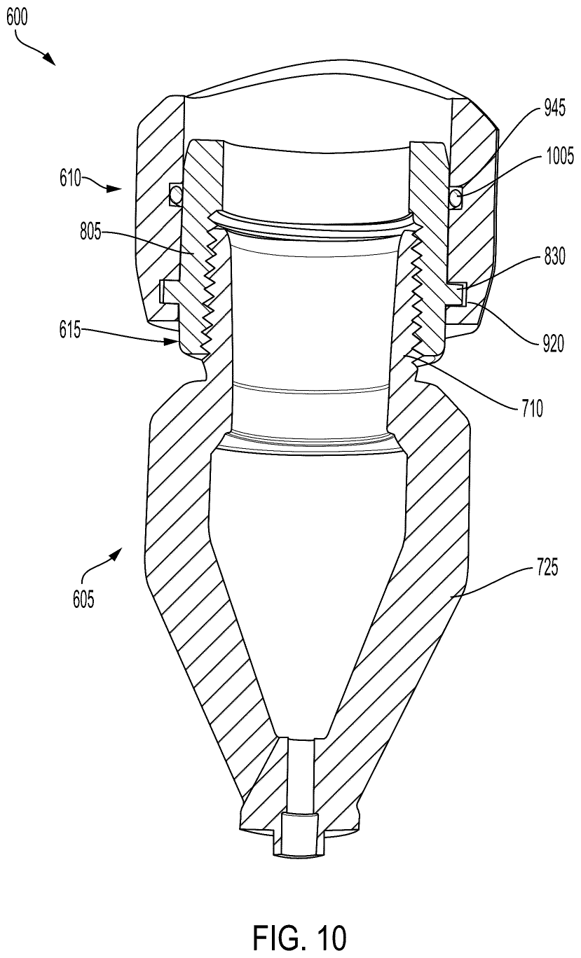

FIG. 10 depicts an example cross-sectional view of the sprinkler assembly 600. At least a portion of the sprinkler 605 can be disposed in the adapter 615. For example, at least a portion of the body 710 can be disposed in the cavity 810. The engagement feature 720 of the sprinkler 605 can engage the engagement feature 825 of the adapter 615 to couple the sprinkler 605 with the adapter 615.

At least a portion of the adapter 615 can be disposed in the fitting 610. For example, at least a portion of the adapter body 805 can be disposed in the fitting cavity 905. The outer wall 815 of the adapter body 805 can interface with the inner wall 915 of the fitting 610.

The sprinkler assembly 600 can include at least one seal element 1005. The seal element 1005 can be at least partially disposed in the seal slot 945. The seal element 1005 can form a seal between the fitting 610 and the adapter 615. The seal element 1005 can be, for example, a gasket or other compliant member that can form a seal.

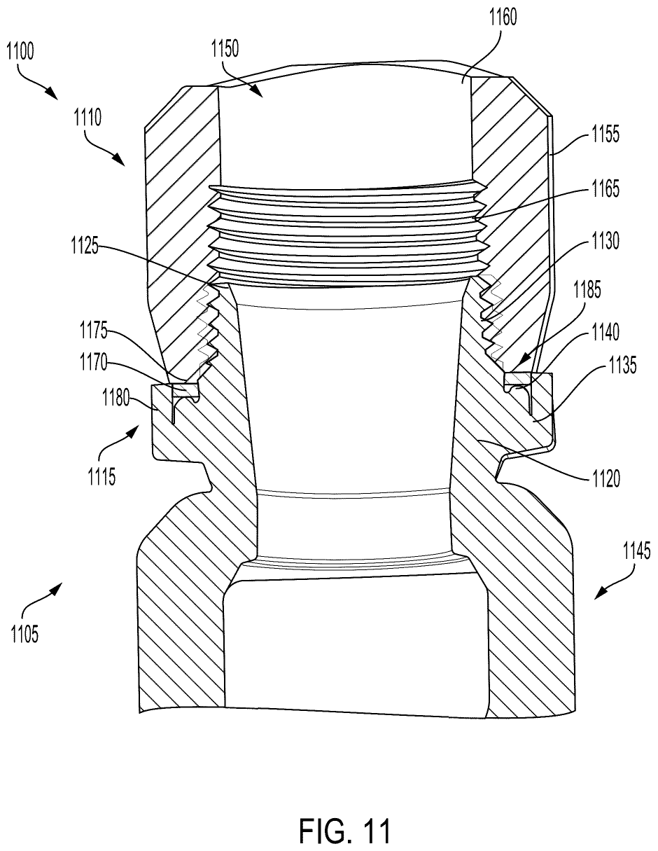

FIG. 11 depicts an example cross-sectional view of a sprinkler assembly 1100. The sprinkler assembly 1100 can be a part of a sprinkler system 100. For example, the sprinkler assembly 105 can be or include sprinkler assembly 1100. The sprinkler assembly 1100 can couple with a piping 110 of a sprinkler system 100. The sprinkler system 100 can include a plurality of sprinkler assemblies 1100.

The sprinkler assembly 1100 can include at least one sprinkler 1105. The sprinkler 1105 can be any sprinkler 1105 that can receive a fire suppressant fluid 120 and dispense the first suppressant fluid 120. For example, the sprinkler 1105 can be a rapid install sprinkler (RIS) 1105. The sprinkler assembly 1100 can include at least one fitting 1110. The fitting 1110 can couple the sprinkler assembly 1100 with the piping 110. For example, the fitting 1110 can be a welded outlet to couple with the piping 110. The fitting 1110 can couple with the sprinkler 1105. The fitting 1110 can couple the sprinkler 1105 with the piping 110.

The sprinkler 1105 can include at least one base 1115. The base 1115 can include at least one body 1120. The body 1120 can define a first sprinkler end 1125 of the sprinkler 1105. The base 1115 can include at least one engagement feature 1130. The engagement feature 1130 can be, for example, a threaded portion. The engagement feature 1130 can couple the sprinkler 1105 with the fitting 1110. For example, the engagement feature 1130 can engage a corresponding engagement feature of the fitting 1110. The engagement feature 1130 can extend around an outer surface of the body 1120.

The base 1115 can include at least one flange 1135. The flange 1135 can extend radially outward from a side of the base 1115. The flange 1135 can extend around a perimeter of the base 1115. The engagement feature 1130 can be disposed between the first sprinkler end 1125 and the flange 1135. The flange 1135 can have at least one flange surface 1140. The flange surface 1140 can face the first sprinkler end 1125. The flange surface 1140 can form a seal with the sprinkler 1105 coupled with the fitting 1110.

The sprinkler 1105 can include at least one frame 1145. The frame 1145 can extend from the base 1115. The engagement feature 1130 can be disposed between the frame 1145 and the first sprinkler end 1125. The flange 1135 can be disposed between the frame 1145 and the first sprinkler end 1125. The frame 1145 can extend in an axial direction opposite the body 1120.

The fitting 1110 can couple with a sprinkler 1105. For example, at least a portion of the body 1120 of the sprinkler 1105 can be disposed in the fitting 1110. The fitting 1110 can couple a sprinkler 1105 with piping 110. The fitting 1110 can define at least one cavity 1150. For example, the fitting 1110 can have at least one outer wall 1155 and at least one inner wall 1160. The inner wall 1160 can define the cavity 1150. At least a portion of the sprinkler 1105 can be disposed in the cavity 1150. For example, at least a portion of the body 1120 can be disposed in the cavity 1150 with the sprinkler 1105 coupled with the fitting 1110.

The fitting 1110 can include at least one engagement feature 1165. The engagement feature 1165 of the fitting 1110 can be, for example, a threaded portion. The engagement feature 1165 of the fitting 1110 can couple the fitting 1110 with the sprinkler 1105. For example, the engagement feature 1165 of the fitting 1110 can interface with the base 1115 of the sprinkler 1105. For example, the engagement feature 1165 of the fitting 1110 can engage the engagement feature 1130 of the sprinkler 1105 to couple the sprinkler 1105 with the fitting 1110.

The sprinkler assembly 1100 can include at least one seal element 1170. The seal element 1170 can form a seal between the fitting 1110 and the sprinkler 1105. For example, the fitting 1110 can include at least one fitting surface 1175. The fitting surface 1175 can face the flange 1135 of the sprinkler 1105. The seal element 1170 can be disposed between the fitting surface 1175 and the flange surface 1140. The seal member 1170 can interface with the fitting surface 1175 and the flange surface 1140 with the sprinkler 1105 coupled with the fitting 1110 to form a seal between the fitting 1110 and the sprinkler 1105. The seal element 1170 can be, for example, a gasket or other compliant member that can form a seal.

The sprinkler assembly 1100 can include at least one projection 1180. The projection 1180 can extend from the flange 1135 toward the fitting 1110. The projection 1180 can extend around the seal element 1170. For example, the projection 1180, the flange surface 1140, and the body 1120 of the base 1115 of the sprinkler 1105 can form a pocket 1185. The pocket 1185 can receive the seal element 1170. The projection 1180 can form an outer wall of the pocket 1185 to at least partially enclose the seal element 1170 with the sprinkler 1105 coupled with the fitting 1110.

Having now described some illustrative examples, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A sprinkler assembly, comprising:
a sprinkler comprising:
a base comprising a body and an engagement tab extending from the body; and
a frame extending from the base; and
a fitting coupled with the sprinkler, the fitting comprising an engagement slot to receive the engagement tab of the sprinkler; and
a seal slot defined by at least one of the base of the sprinkler and the fitting, the seal slot to receive a seal element to form a seal between the fitting and the sprinkler.

2. The sprinkler assembly of claim 1, comprising:
the base of the sprinkler comprising a flange; and
the fitting comprising a fitting surface;
the engagement tab and at least a portion of the body to be disposed in the fitting and the flange to contact the fitting surface.

3. The sprinkler assembly of claim 1, comprising:
the engagement slot, comprising:
a rotational portion to facilitate rotation of the sprinkler with the engagement tab in the rotational portion;
an inlet to receive the engagement tab, the inlet extending from the rotational portion in a direction a first distance and through an end of the fitting; and
a retention pocket to retain the engagement tab, the retention pocket extending from the rotational portion in the direction a second distance, the second distance shorter than the first distance.

4. The sprinkler assembly of claim 1, comprising:
the engagement slot, comprising:
a rotational portion to facilitate rotation of the sprinkler with the engagement tab in the rotational portion; and
an inlet to receive the engagement tab, the inlet extending from the rotational portion in a direction a first distance and through an end of the fitting.

5. The sprinkler assembly of claim 1, comprising:
the fitting comprising an inner wall; and
the engagement slot extending into the inner wall, the engagement slot comprising a rotational portion extending circumferentially along the inner wall to facilitate rotation of the sprinkler relative to the fitting.

6. The sprinkler assembly of claim 1, comprising:
the sprinkler comprising a plurality of engagement tabs including the engagement tab; and
the fitting comprising a plurality of engagement slots including the engagement slot, the plurality of engagement slots to receive the plurality of engagement tabs to couple the sprinkler with the fitting.

7. The sprinkler assembly of claim 1, comprising:
the fitting comprising a plurality of engagement slots including the engagement slot, the plurality of engagement slots positioned to align the sprinkler with an axis of piping to couple with the fitting.

8. The sprinkler assembly of claim 1, comprising:
the engagement slot extends partially around an inner surface of the fitting.

9. The sprinkler assembly of claim 1, comprising:
the engagement slot extends in a plane perpendicular to an axis through the fitting.

10. The sprinkler assembly of claim 1, comprising:
the seal element is at least one of lubricated or pre-swelled.

11. A sprinkler assembly, comprising:
a sprinkler, comprising:
a base; and
a frame extending from the base;
an adapter coupled with the sprinkler, a portion of the base to be disposed in the adapter, the adapter comprising an engagement tab; and
a fitting coupled with the adapter, the fitting comprising an engagement slot to receive the engagement tab; and
a seal slot defined by at least one of the adapter or the fitting, the seal slot to receive a seal element to form a seal between the fitting and the adapter.

12. The sprinkler assembly of claim 11, comprising:
the sprinkler comprises a deflector to be oriented according to engagement of the fitting with the adapter.

13. The sprinkler assembly of claim 11, comprising:
the frame comprises a plurality of frame arms, the frame arms defining an axis to be oriented to a target orientation according to engagement of the fitting with the adapter.

14. The sprinkler of assembly of claim 11, comprising:
a plurality of engagement slots comprising the engagement slot.

15. The sprinkler of assembly of claim 11, comprising:
a plurality of engagement slots comprising the engagement slot, the plurality of engagement slots extending partially around an inner circumference of the fitting.

16. The sprinkler assembly of claim 11, comprising:
the engagement slot extends from a first end of the fitting towards a second end of the fitting opposite the first end and extends along an inner surface of the fitting.

17. The sprinkler assembly of claim 11, comprising:
the fitting comprises a curved end to contact piping to couple the piping with the sprinkler.

18. A sprinkler assembly, comprising:
a sprinkler, comprising:
a base;
a frame extending from an end of the base; and
a flange extending radially from a side of the base;
a fitting coupled with the sprinkler, the fitting comprising:
a fitting surface facing the flange; and
an engagement feature to interface with the base to couple the sprinkler with the fitting; and
a seal element disposed between the flange and the fitting surface to form a seal between the sprinkler and the fitting.

19. The sprinkler assembly of claim 18, comprising:
the engagement feature comprises at least one of a slot and a tab.

20. The sprinkler assembly of claim 18, comprising:
the frame comprises a plurality of frame arms coupled with a deflector, the engagement feature to limit rotation of the sprinkler relative to the fitting to orient the deflector and the frame arms to a target orientation.
